(19) United States
(12) Patent Application Publication
(10) Pub. No.: US 2004/0041843 A1
(43) Pub. Date: Mar. 4, 2004

(54) Inserting complex comments in a document

(76) Inventors: Yong Cui, Plano, TX (US); Rick Harris, Shady Shores, TX (US); Dale Philbrick, Dallas, TX (US)

Correspondence Address: TEXAS INSTRUMENTS INCORPORATED, P O BOX 655474, M/S 3999, DALLAS, TX, 75265

(21) Appl. No.: 10/232,068

(22) Filed: Aug. 30, 2002

(51) Int. Cl. G09G 5/00

(52) U.S. Cl. 345/810

(57) ABSTRACT

A software application and user interface that is capable of inserting comments into a document with embedded objects and providing more complex comment options. An embodiment of the present invention is an application program on a handheld computing device or other computer. The user can insert complex comments into a document including muti-media and nested comments. The user can also do mathematic calculations within the comment without altering the existing content of the commented document. Another feature is a “scaffold comment,” which is a comment that has a pre-defined portion. The comments can have unique comment icons to readily show the user what type of comment is embedded in the document. Another feature is the nested comments can be stored as an XHTML file and viewed with an XHTML file browser.

### TECHNICAL FIELD OF THE INVENTION

This invention relates to electronic computing devices and software on those devices, and more particularly to a method for inserting comments into a document with embedded objects and providing comment options including pre-defined “scaffold” comments, live math, multimedia and nested comments.

### BACKGROUND OF THE INVENTION

Comment insertion is known in the prior art. Comments have been used in conjunction with other documents such as a word processing documents. For example, U.S. Pat. No. 5,710,928 describes a word processing process linked to a spreadsheet process. This technique is used in Microsoft Incorporated's popular word processing application “Microsoft Word™.” Document processing systems such as this allow a user to prepare compound documents. A compound document is a document that contains information in various formats embedded in the document. For example, it may contain data in text format, charts and/or numerical format. In this prior art, a user is able to insert comments into the compound document.

### SUMMARY OF THE INVENTION

The present invention provides a user interface for a computing device and a software application that is capable of inserting comments into a document with embedded objects and providing more complex comment options.

An embodiment of the present invention is an application program operating on a handheld computing device such as a PDA (personal digital assistant), PLT (personal learning tool), calculator or other computer. The user can insert complex comments into a document including multi-media and nested comments. A special icon appears in the text to identify the type of comment embedded at that location in the text. When displayed, the comments are preferably shown embedded with the text of the document wrapped or flowing around it.

In another embodiment, the user can also perform mathematic calculations within the comment. In some embodiments, the comment is a unique math domain such that math operations within the comment will not alter the existing content of the commented document.

In an embodiment, portions of the comment text can be edited, while other portions can not be edited. This feature may be advantageously combined with another embodiment, one in which a comment has a pre-defined portion, or a “scaffold comment.” Unique comment icons can also be advantageously combined with scaffold comments.

In another embodiment of the present invention, documents with comments and nested comments are stored as an XHTML file. The comments can then be viewed with an XHTML file browser.

### BRIEF DESCRIPTION OF THE DRAWINGS

FIG. 1 illustrates a hand-held device having features according to the present invention.

FIGS. 2a-e illustrate the screen display of a hand-held computer device according to an embodiment of the present invention.

FIGS. 3a-c illustrate the screen display of a hand-held computer device according to an embodiment of the present invention.

FIGS. 4a-b illustrate the screen display showing inserting of multi-media objects on a handheld computer device according to an embodiment of the present invention.

FIGS. 5a-f illustrate the screen display showing scaffolding comments on a hand-held computer device according to an embodiment of the present invention.

FIG. 6 illustrates the screen display showing comments are stored as an XHTML file on a hand-held computer device according to an embodiment of the present invention.

FIGS. 7a-b illustrates the screen display showing nested comments are stored as an XHTML file on a hand-held computer device according to an embodiment of the present invention.

### DETAILED DESCRIPTION OF THE INVENTION

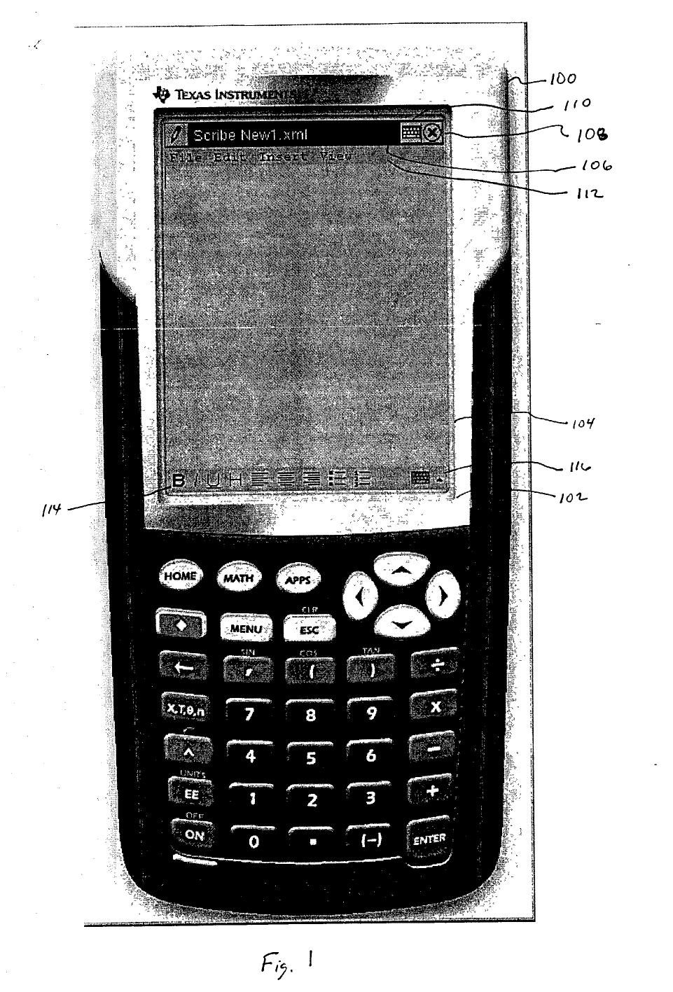

FIG. 1 illustrates a computer or hand held computing device 100 that incorporates features of the present invention. The device has a display screen 102 having a display area 104. In this embodiment, the display is a touch sensitive display that uses a stylus for input (not shown).

The display includes a header bar 106 that shows the current tool (in this case a compound document editor tool called “scribe”). The file name of the current open document on the display is also shown on the header bar. In addition, the header bar shows an icon for closing the tool 108 and a keyboard icon 110 to bring up a “QWERTY” keyboard on the display for input of characters with the stylus. The display area 104 further includes a top button bar 112 that has drop down menus for file, edit, insert and view functions. The display area 104 also has a bottom button bar 114 that has text formatting options, a keyboard button, and an icon 116 to pop-up another menu for inserting text symbols.

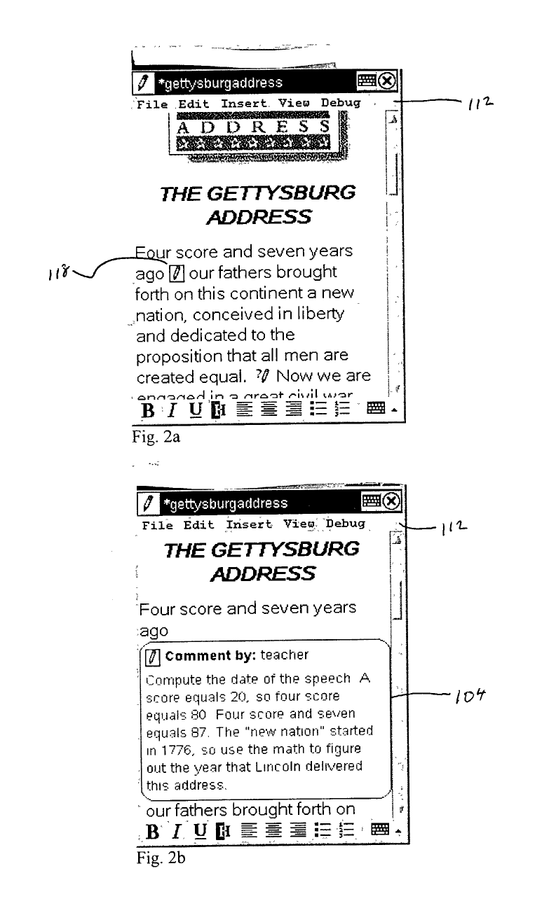

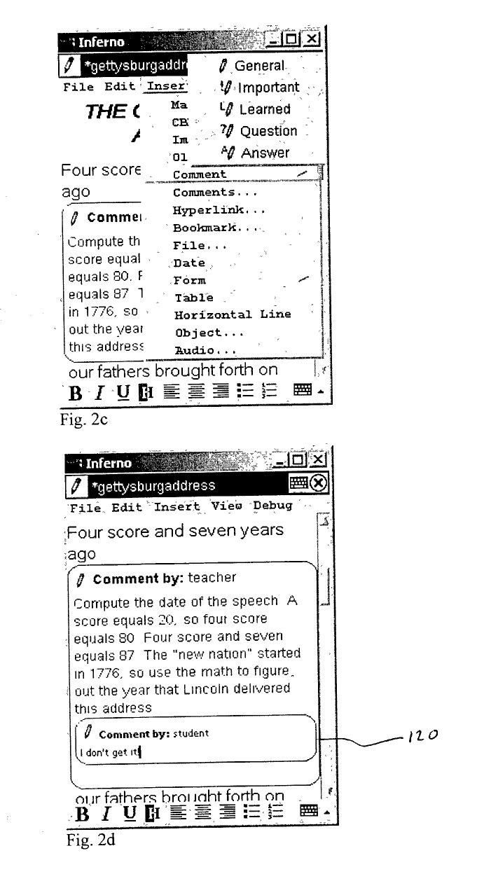

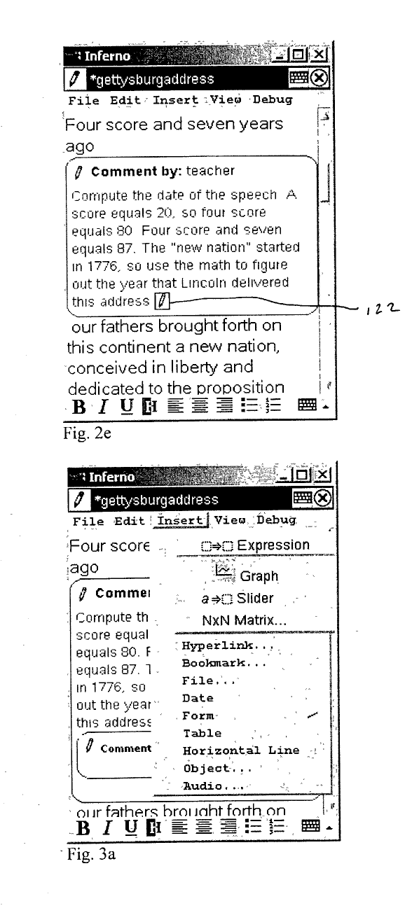

In an embodiment of the present invention, the display area 104 of a computer device is shown in FIG. 2a. This computer device may be a personal computer, a hand-held computer or other computing device as described above. The document on the screen represents a compound document which incorporates the comment features of the present invention. The location and existence of embedded comments are represented by an icon 118 shown in the text. In this embodiment, the icon used is a picture of a pencil. If the user selects the icon, for example by touching the icon with the stylus, the embedded comment is then displayed as shown in FIG. 2b. Preferable, the text of the document flows around the expanded comment such that the location of the comment is maintained within the text of the document. In an embodiment of the present invention, a comment indicates within the comment who originated the comment as shown in the top line of the comment in FIG. 2b. In FIG. 2b, the originator is “teacher.”

In another embodiment of the present invention, other comments can be nested within a comment. For example, beginning with the display 104 shown in FIG. 2b, a user can select the “insert” functions from the top button bar 112. A drop down menu with several insert options is then displayed as shown in FIG. 2c. The user can then select the type of object to insert into the comment. In this example, the user is selecting a comment to be within the first comment. The user selects the comment function as shown in FIG. 2c. A nested comment box 120 is then displayed inside the first comment as shown in FIG. 2d. In this example, the originator of the comment is the student as shown in the new comment box 120. The user can then insert text or other objects into the comment. In this example, the student has entered the response “I don't get it!” as shown in FIG. 2d. The user can close the nested comment by selecting the embedded icon in the comment header (the bold top line of the comment). The comment is then collapsed to the comment icon 122 as shown in FIG. 2e. The nested comment icon is shown just like the top level comment icon, in the location of the text where the comment resides. In this example, the nested comment is shown in the text of the top level comment. The top level comment can also be closed by selecting the comment header. After closing the comment in FIG. 2e, the screen would then again look like the screen display shown in FIG. 2a. The icon for a comment having a nested comment could be different to distinguish over a single level comment.

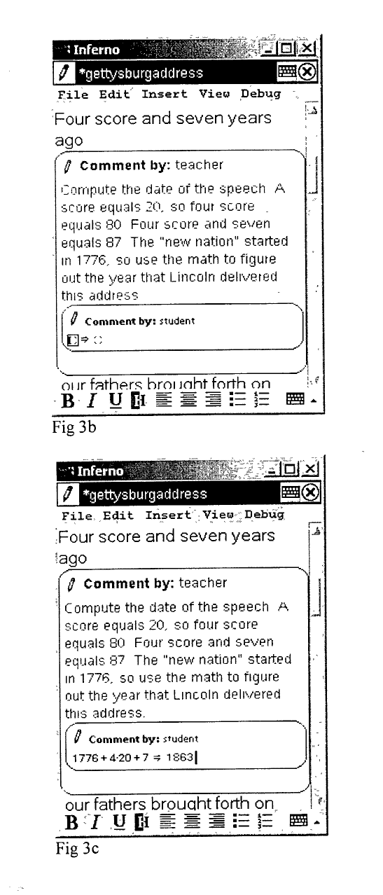

In another embodiment of the present invention, other objects can be inserted within a comment. For this example, a math expression is to be placed into a student comment to reply to the teacher's request in the teacher' comment. Beginning with the display 104 shown in FIG. 2b, a user selects the “insert” functions from the top button bar 112. The drop down menu with insert options is then displayed as shown in FIG. 2c. The user can then select the type of object to insert into the comment. The user first selects a comment object to be placed within the first comment as described above. The user can now insert a math function into the nested comment. The user selects the insert math function from the insert drop down menu shown in FIG. 2c. After selection of the insert math function, a menu of math types is displayed as shown in FIG. 3a. The student user can then select to insert a mathematical expression into the comment as shown in FIG. 3b. In this example, the student has entered the expression “1776+(4*20)+7=1863” as shown in FIG. 3c.

In a preferred embodiment, the live math in the comment is a new domain such that any definitions in the comment do not change math expressions outside the comment. The math in the comment can be done with system calls to the math engine operating outside the commented document.

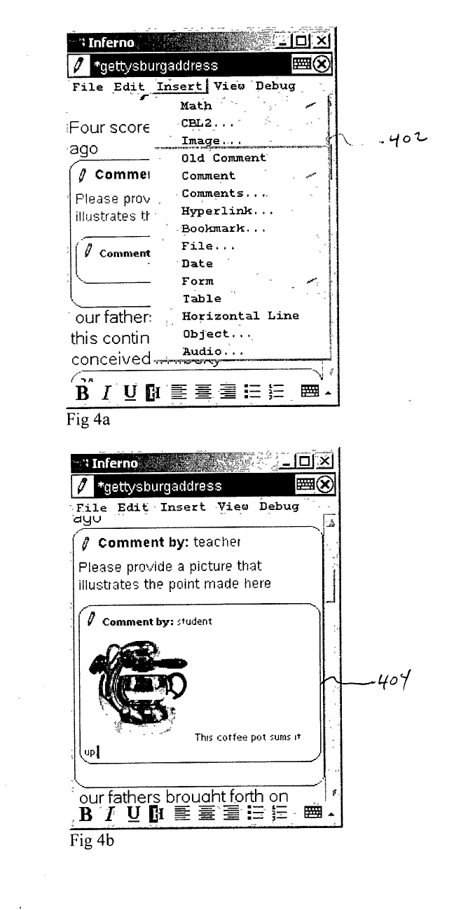

In yet another embodiment of the present invention, other multi-media objects can be inserted within a comment. For example, a picture is to be placed into a student comment to reply to a teacher's request in a teacher' comment. In the example illustrated in FIG. 4, the student responds to the teachers request by first inserting a comment into the teachers question comment as described above. The student then inserts an image into the comment by selecting “insert” on the menu, and then selecting the image command 402 as shown in FIG. 4a. The student may then select an image from a list of images stored in memory or other location (not shown). FIG. 4b shows the resulting response comment 404 with an image inserted into the comment, along with a text response.

In an embodiment of the present invention, multiple types of pre-defined comments can be inserted into the document or into another comment. These comments preferably have a unique icon to graphically identify the comment type. FIG. 2c illustrates a first way of allowing the user to select one of several types. In this case the comment types have a unique icon to graphically represent the comment type in the document.

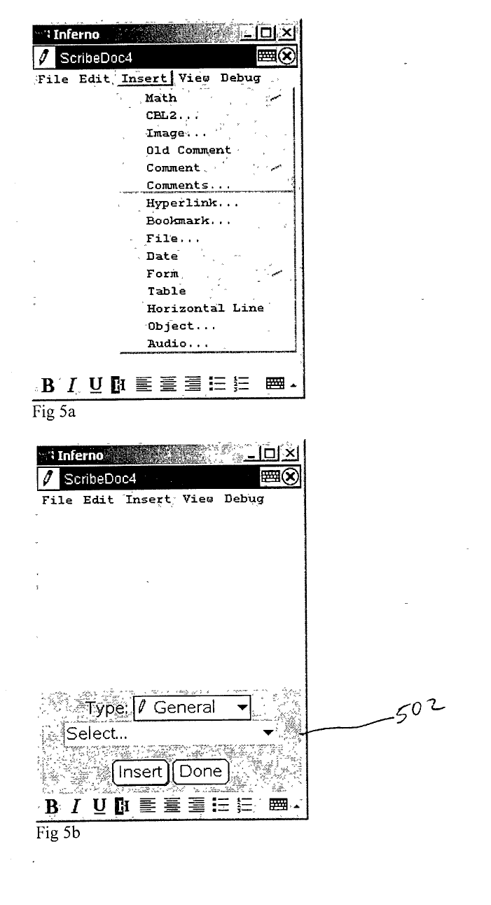

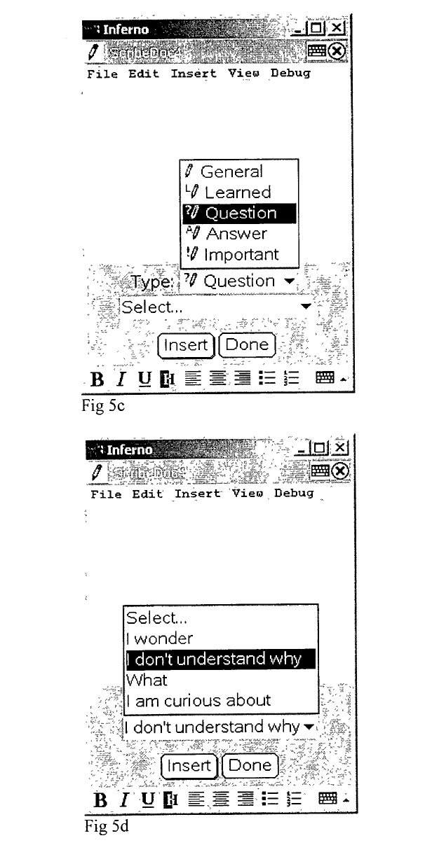

Another embodiment with multiple types of pre-defined comments is shown in FIGS. 5a-f. In contrast to FIG. 2c, this multiple comment type embodiment allows the user to further select a pre-defined text phrase to be included in the comment. In the embodiment, when the user selects to insert a comment as shown in FIG. 5a, a comment options box 502 is displayed as shown in FIG. 5b. The comment options box allows the user to select the comment type 504, scaffold text 506. The user clicks on the comment type down menu 504 to display the available comment types 508 as shown in FIG. 5c. Each of the comment types (General, Learned, Question, Answer, Important) is shown with the corresponding comment icon. After selecting the type, the user clicks on the comment select box menu 510 to display the available comment scaffolding text 512. The scaffolding of comments allows the user to quickly insert meaningful comments with a minimum of keystrokes. In FIG. 5d the user has selected “I don't understand why.” After clicking on the selected scaffolding comment, the comment is inserted into the document with the scaffolded text as shown in FIG. 5e. The comment icon 514 corresponds to the comment type selected. In this example, a question mark with the pencil. In some embodiments, the teacher can modify and add types of comments and their available scaffolding text by editing a file that contains the available types.

In another embodiment of the present invention, embedded comments and nested comments are created with an XHTML editor operating on an XHTML document file. The comments can be stored within the document as an XHTML file structure. The comments can then be viewed within the document with an XHTML file browser. In an embodiment of the present invention, the XHTML file includes unique codes to control what portions of the comment text can be edited with the XHTML editor.

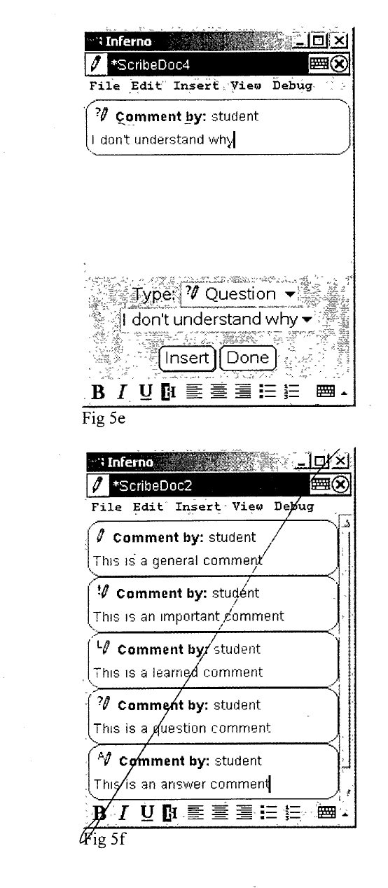

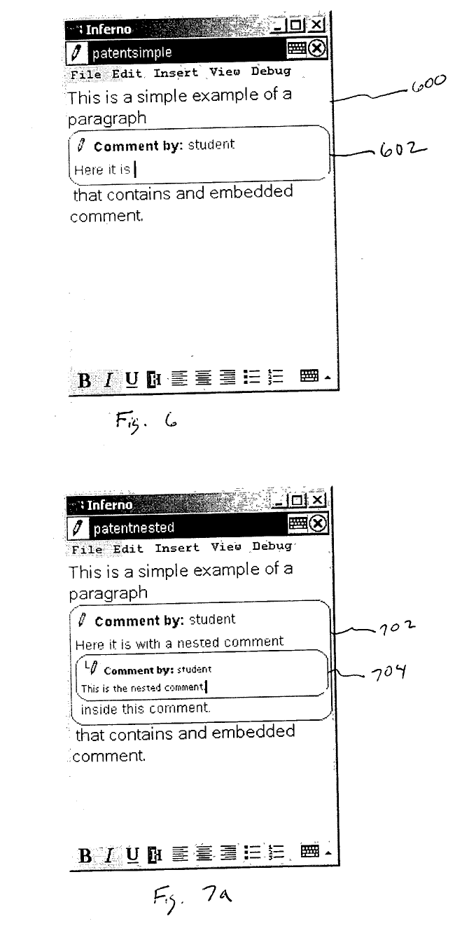

A comment in a text file can be created using the user interface steps described above to produce the screen shown in FIG. 6. This screen can be represented with an XHTML structure. For example, a comment 602 is shown embedded in text in the display 600 of FIG. 6. In this embodiment, the XHTML editor which is operating to create the document file shown would create and insert into the document file a comment structure. An example of the comment XHTML structure and an embodiment of the present invention is shown below:

<html xmlns=′http://www.w3.org/1999/xhtml′xmlns:m′http://www.w3.org/1998/Math/MathML′>

<head>

<title>patentsimple</title>
<link rel=′stylesheet ′href=′/default.css′ type′text/css′></link>
<script language=′JavaScript1.2 ′src′/comments.js′></script>

</head>
<body>

<p>This is a simple example of a paragraph

<div class=′inlinemin′ ticomment=′general ′tipattern=′%s′>

<button class=′hidden ′tiindexable=′false ′tireadonly=′true′
onclick=′openComment(this)′><img
tiindexable=′false ′src=′/dis/scribe/res/icons/commentgeneric.gif′></img>

</button>

<div tiindexable=′false′class=′comment′>
<p class′header′tiindexable=′allfalse′>

<button class=′inlinemin′ onclick=′closeComment(this)′>

<img src=′/dis/scribe/res/icons/commentgeneric.gif′></img>

</button><b>&nbsp;Comment by:&nbsp;</b>student</p>

<p tiarg=′0′>Here it is.</p>

</div>

</div> that contains and embedded comment.</p>

</body>

</html>

The above XHTML structure can be seen to comprise a single parent (<div class=‘inlinemin’ ticornment=‘general’ . . . ) having two children (a button and another div). Each of the children has a button. Only one of the children and its button is visible at any one time. This structure allows the comment to be shown as either an icon in the document text, or the complete comment box 602 with the comment text and a return comment icon as shown in FIG. 6a. As described above, if the user clicks on the button shown in FIG. 6a, the comment will collapse into the icon. This is accomplished with the comment structure above by the “onclick” command which executes the java script “openComment” or “closeComment” listed below. The java script swaps the two children portions of the comment from displayed to hide and hide to display. This is done by changing the “class” attribute from “inline” to “hidden” and from “hidden” back to “inline”.

Below is relevant contents of the /default.css file referenced in the above comment structure file:

| | |
|---|---|
| .comment | {font-size: smaller; display: block; border-style: |
| | solid; border-roundness: 12px;border-width: 1px; |
| | border-color: red; color: green; padding-left: |
| | 4px;padding-right: 2px; } |

| | |
|---|---|
| .header | {color: red; padding-bottom: 0px; } |

| | |
|---|---|
| .hidden | {display: none } |
| .inline | {display: inline } |

| | |
|---|---|
| .block | {display: block } |
| .inlinemin | {display: inline; padding-top: 0px; padding- |

bottom: 0px; padding-left: 0px; padding-right: 0px;
timinsize: 1; align: middle}

Below is the contents of the /comments.js file referenced above:

function openComment (elem)
{

elem.className = ′hidden′;
elem.parentNode.lastChild.className = ′comment′;

}
function closeComment(elem)
{

var cmt = elem.parentNode.parentNode;
cmt.className =′hidden′;
cmt.parentNode.firstChild.className = ′inlinemin′;

}

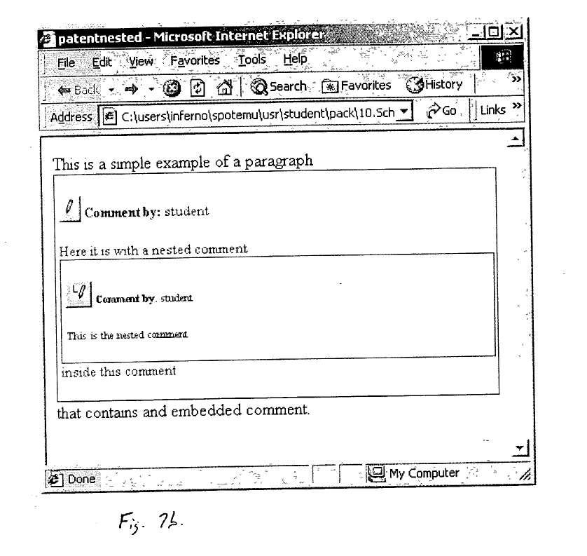

Similarly, a nested comment can be represented in an XHTML structure. A nested comment in a text file can be created using the user interface steps described above to produce the screen shown in FIG. 7a. This screen can be represented with an XHTML structure as shown below:

<htmlxmlns=′http://www.w3.org/1999/xhtml′xmlns:m=′http://www.w3.org/MathML′>

<head>

<title>patentnested</title>
<link rel=′stylesheet′ href=′/default.css′ type=′text/css′></link>
<script language=′JavaScript1.2′ src′/comments.js′></script>

</head>
<body>

<p>This is a simple example of a paragraph

<div class=′inlinemin′ ticomment=′general′ tipattern=′%s′>

<button class=′hidden′ tiindexable=′false′ tireadonly=′true′

onclick=′openComment(this) ′>

<img tiindexable=′false′

src=′/dis/scribe/res/icons/conmentgeneric.gif′></img>

</button>
<div tiindexable′false′ class=′comment′>

<p class=′header′ tiindexable=′allfalse′>

<button class=′inlinemin ′onclick=′closeComment (this) ′>

<img src=′/commentgeneric.gif′></img>

</button><b>&nbsp;Comment by:&nbsp;</b>student</p>

<p tiarg=′0′>Here it is with a nested comment

<div class= ′inlinemin′ ticomment=′learned′ tipattern=′%s′>

<button class= ′hidden′ tiindexable=′false′ tireadonly=′true′

onclick=′openComment(this) ′>

<img src=′/commentlearning.gif′></img>

</button>
<div tiindexable=′false′ class=′comment′>

<p class=′header′ tiindexable=′allfalse′>

<button class=inlinemin′ onclick=′closeComment(this) ′>

<img src=′/commentlearning.gif′></img>

</button><b>&nbsp;Comment by:&nbsp;</b>student</p>

<p tiarg=′0′>This is the nested comment.</p>

</div>

</div> inside this comment.</p>

</div>

</div>that contains and embedded comment.</p>

</body>

</html>

The above structure represents a nested comment as shown in FIG. 7a. A comment 702 has a nested comment 704. This comment structure could be viewed with a internet browser and displayed as shown in FIG. 7b. Similarly, the other comments describe herein could also be viewed in this manner.

Another feature and embodiment of the present invention is a comment structure that controls what portions of the comment the user can edit. In the above embodiments, this feature is accomplished with a unique code to tell the XHTML editor where to index the cursor. In the above example, this code is tiindexable=‘false’. A similar code can be used to prevent any editing on the entire line. This code in the above example is tiindexable=‘allfalse’.

Other Embodiments

Although the present invention has been described in detail, it should be understood that various changes, substitutions, and alterations could be made hereto without departing from the spirit and scope of the invention as defined by the appended claims.

The features that are the subject of the present invention could be incorporated into other into other computer based teaching tools and computers. Similarly, other embodiments include the same user interface functionality in a ROM software application package that is executed on a computer, graphing calculator or other handheld device.

What is claimed is:

1. A software program stored on a computer media for a computer device which provides a user interface comprising:
a display area;
a document including text displayed on the display area, and
an icon representing a comment shown within the document and which represents the location of the comment.

2. The software program of claim 1, wherein activation of the icon displays the comment within the text of the document at the icon location with the text of the document formatted around the comment.

3. The software program of claim 1, wherein the comment contains a nested comment.

4. The software program of claim 3, wherein the nested comment has a unique icon to identify the comment as a nested comment in the document when the comment is closed.

5. The software program of claim 1, wherein the comment contains multi-media objects.

6. The software program of claim 3, wherein the nested comment contains multi-media objects.

7. The software program of claim 1, wherein the comment contains a header icon to activate closing of the comment in the document.

8. The software program of claim 1, wherein the comment is stored as an XHTML file which can then be viewed with an XHTML file browser.

9. The software program of claim 8, wherein the XHTML comment file has a single parent two children structure where one child is displayed and one is child hidden.

10. The software program of claim 9, wherein the XHTML comment file is embedded with a nested comment of the same structure.

11. A handheld computing device comprising:
a display screen;
an input device for operating the computing device and entering user responses;
a processor for executing application programming that provides a user interface to the application wherein the user interface further comprises:
a display area;
a document including text displayed on the display area, and
an icon representing a comment shown within the document and which represents the location of the comment.

12. The handheld computing device of claim 11, wherein activation of the icon displays the comment within the text of the document at the icon location with the text of the document formatted around the comment.

13. The handheld computing device of claim 11, wherein the comment contains a nested comment.

14. The handheld computing device of claim 11, wherein the comment is stored as an XHTML file which can then be viewed with an XHTML file browser.

15. The handheld computing device of claim 13, wherein the nested comment has a unique icon to identify the comment as a nested comment in the document when the comment is closed.

16. The handheld computing device of claim 11, wherein the comment contains multi-media objects.

17. The handheld computing device of claim 12, wherein the nested comment contains multi-media objects.

18. The handheld computing device of claim 12, wherein the comment contains a header icon to activate closing of the comment in the document.

19. A software program stored on a computer media for a computer device which provides a user interface comprising:
a display area;
a document including text displayed on the display area, and
a selection capability to select from a plurality of predetermined comment structures a comment to insert into the document at a selected location.

20. The software program of claim 19, wherein a plurality of the predetermined comment structures include text phrases or text questions to prompt the user to use a formulated response.

21. The software program of claim 19, wherein a plurality of the predetermined comment structures have unique icons which display at the location of the comment in the document when the comment is closed.

22. The software program of claim 19, wherein the predetermined comment structures have portions of text that can't be edited after the comment is inserted into the document.

23. The software program of claim 19, wherein the comment contains a header icon to activate closing of the comment in the document.

24. The software program claim 19, further comprising an icon representing the comment shown within the document and which represents the location of the comment.
